(19) United States
(12) Patent Application Publication
(10) Pub. No.: US 2005/0158438 A1
(43) Pub. Date: Jul. 21, 2005

(54) Recipe for a bread substitute coating for food products

(76) Inventor: David McMahon II, Duluth, GA (US)

Correspondence Address: Joseph G. Mitchell, Esq., 4521 Derby Lane, Smyrna, GA, 30082, US

(21) Appl. No.: 10/758,927

(22) Filed: Jan. 16, 2004

(51) Int. Cl. A21D 13/04

(52) U.S. Cl. 426/550

(57) ABSTRACT

The present invention relates to a recipe for a breadless breading substitute to be used, instead of bread or batter, for the purpose of coating foods or mixing in food to create a low carbohydrate product. The recipe comprises almond meal, flax seed meal, soy flour and seasoning to form a healthy, gluten free product. When applied to food, such as chicken tenders, and then fried in oil or baked in an oven, the result is the creation of a breadless breading texture that is tasty and low in fat.

### BACKGROUND OF THE INVENTION

1. Field of the Invention

The field of invention relates to a recipe for a breadless breading substitute to be used, instead of bread, for the purpose of coating foods or mixing in food to create a low carbohydrate product.

2. Description of Prior Art

Breading, dusting, flouring and otherwise coating foods prior to cooking is popular among U.S. consumers because of the flavorful taste, crisp texture, and typically golden brown appearance resulting therefrom. In recent years, dry mixes and convenience-oriented products have become available for easier, less time-consuming preparation of coated foods which are cooked by roasting, baking, broiling, frying and the like.

Foods such as meat, fish, poultry and vegetables are conventionally coated (breading or batter) prior to cooking by pan frying, deep fat frying or baking. The intent of many of these coating and cooking procedures is to obtain a coating with the taste, texture and appearance associated with fried foods. One such procedure involves the initial coating of the food with a liquid batter followed by the application of a particulate farinacious material or breading to the batter coated surface. The coated food is then either fried or baked (see U.S. Pat. Nos. 3,723,137, 3,676,158, and 3,843,827). Alternatively, the food can be initially coated with a specially formulated dry mix followed by baking to impart a fat fried appearance, texture and taste to the baked food (see U.S. Pat. Nos. 3,852,501 and 3,586,512).

The intent of many of the coating and cooking procedures disclosed in the above-referenced patents is to obtain a coating which has the taste, texture, and appearance associated with fried foods. This effort is undoubtedly a result of the public's seemingly insatiable appetite for fried foods. Lately, however, consumers are becoming increasingly health-conscious, as evidenced by the fact that many consumers are turning to foods which are high in nutritional value and low in cholesterol, saturated fat, and caloric content. Consumers have also shown concern regarding the use of preservatives to enhance the shelf life of certain products. The trend toward healthier foods is likely a reaction to recent medical findings which show that a high intake of fat and cholesterol may lead to arterial and heart disease. The public's reaction to these findings has placed an increased emphasis on the ingredients and processing techniques used to create coated foods.

It is therefore desirable to provide a recipe for a breadless breading substitute to be used, instead of bread, for the purpose of coating foods or mixing in food to create a low carbohydrate product. The present invention provides satisfying taste, nutrition, texture and appearance, which is low in cholesterol, saturated fat, and caloric content. The present invention provides such a food coating and the method for manufacturing same.

### SUMMARY OF THE INVENTION

The purpose of the invention, then, is to provide a recipe for a breadless breading substitute to be used, instead of bread, for the purpose of coating foods or mixing in food to create a low carbohydrate product.

A brief summary of the invention follows. The invention comprises a number of ingredients and when combined in a certain method, it makes a great bread substitute or breadless breading coating to be used on food or eaten by itself The invention is a recipe that comprises almond meal, flax seed meal, soy flour and seasoning. The seasoning used can be any spice to accommodate for the product one is cooking or such spice or spices can be used to supplement the recipe. One recommendation of combined spices is to use pepper, dehydrated garlic, salt, paprika, dehydrated onions and red pepper.

When the aforementioned ingredients are combined in accordance with the prescribed percentages (detailed later herein), and in the right way, it produces a food coating or food mixture that has the taste and appearance of a bread coating or mixture but has a seventy-five percent (75%), or lower, carbohydrate content and has no bread or grain products. Therefore, the result is a gluten free product. The invention, then, is a much more healthier food than bread or batter and that is great for the consumer.

The invention, which will be detailed later herein, can be used as a food product itself or used as a coating on low carbohydrate chicken tenders, chicken nuggets, chicken breasts (whether stuffed or plain), country fried steak, fried chicken, mozzarella sticks, jalapeno poppers, fried mushrooms, fried zucchini and any number of food products.

The invention resides not in any one of these ingredients per se, but rather in the particular combination of all of them herein disclosed and claimed, and it is distinguished from the prior art in this particular combination for the result specified.

There has thus been outlined, rather broadly, the important features of the invention in order that the detailed description thereof that follows may be better understood, and in order that the present contribution to the art may be better appreciated. There are, of course, additional features of the invention that will be described hereinafter and which will form the subject matter of the claims appended hereto. Those skilled in the art will appreciate that the conception, upon which this disclosure is based, may readily be utilized as a basis for designing of other recipes, methods and procedures for carrying out the several purposes of the present invention. It is important, therefore, that the claims be regarded as including such equivalents insofar as they do not depart from the spirit and scope of the present invention.

Further, the purpose of the foregoing abstract is to enable the U.S. Patent and Trademark Office and the public generally, and especially the scientists, engineers and practitioners in the art who are familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

One objective of this invention, then, is to provide an easy method to make the product.

Another objective of this invention is to provide a product that is better than that on the market, at present, so that it will be well received by the consuming public.

A further objective of the invention is to provide an invention that is economical to purchase for the consuming public.

Yet another objective of the invention is to provide a product that tastes good.

Another objective of the invention is to provide a product that is healthy for the consuming public.

Another objective of the invention is to provide a low carbohydrate product and one that is gluten free.

### DETAILED DESCRIPTION OF THE INVENTION

### The Preferred Embodiment

While the present invention will be described with reference to the preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the present invention not be limited to the particular embodiment disclosed as the best mode contemplated for carrying out this invention, but that the invention will include all embodiments (and legal equivalents thereof) falling within the scope of the appended claims.

The invention comprises a number of ingredients and when combined in a certain method, it makes a great bread substitute or breadless breading coating to be used on food or eaten by itself. The invention is a recipe that comprises almond meal, flax seed meal, soy flour and seasoning. The seasoning used can be any spice to accommodate for the product one is cooking or such spice or spices can be used to supplement the recipe.

The recipe of the current invention and the preferred embodiment is to combine (as will be described later herein) the following ingredients together according to the following percentages as it pertains to the entire mixture:
(1) Approximately 46.67% of the mixture should comprise almond meal;
(2) Approximately 23.33% of the mixture should comprise flax seed meal (it is critical to use the flax seed meal and not flax seed because the human body does not digest flax seed unless grinned down into a fine meal);
(3) Approximately 23.33% of the mixture should comprise soy flour, and
(4) Approximately 6.67% of the mixture should comprise seasoning.
   The preferred seasoning is to use pepper, dehydrated garlic, salt, paprika, dehydrated onions and red pepper. However, any seasoning can be used to accommodate the product one is cooking or using.

The process to combine the ingredients, in the preferred embodiment, as it pertains to 16 ounces or one pound (which is only a representative example) is as follows:
1. Weigh the soy flour to 3.73 oz;
2. Weigh the flax seed meal to 3.73 oz;
3. Weigh the almond meal to 7.46 oz;
4. Weigh the accommodating spice or spices to 1.08 oz;
5. Pour the soy flour in a mixing bowl (it is critical to put the soy flour in the bowl first);
6. Add the flax seed meal to the bowl;
7. Add the almond meal to the bowl;
8. Hand mix the ingredients or use a mixer on the slowest speed for approximately 1 min.;
9. Add the accommodating spice or spices, then mix again for approximately 1 to 2 min. or until the aforementioned ingredients are mixed evenly together.
   Following the above steps creates the present recipe for breadless breading. Of course, the ounces or weight of the each ingredient used would depend on the total weight of all the ingredients but the above provides a representation of how one would make the breadless breading of the present recipe.

The pre-washed food product (for example, chicken, seafood, vegetables, or the like), mixed with egg whites or regular eggs (white preferred), would then be combined with the aforementioned mixture to create a fried breading texture look on the food product. This combination would then be fried in oil or baked in the oven.

The breadless breading mixture or recipe can also take the place of breadcrumbs in making meatballs or meatloaf or the like.

When the ingredients of the invention are combined in accordance with the prescribed percentages, and in the mixed together according to the preferred embodiment, it produces a food coating or food mixture that has the taste and appearance of a bread coating but has a seventy-five percent (75%), or lower, carbohydrate content and has no bread or grain products. Therefore, the result is a gluten free product. The invention, then, is a much more healthier food than bread or batter and that is great for the consumer.

The breadless breading product of the invention or recipe can be used as a food product itself or used as a coating on low carbohydrate chicken tenders, chicken nuggets, chicken breasts (whether stuffed or plain), country fried steak, fried chicken, mozzarella sticks, jalapeno poppers, fried mushrooms, fried zucchini and any number of food products.

The invention resides not in any one of these ingredients per se, but rather in the particular combination of all of them herein disclosed and claimed, and it is distinguished from the prior art in this particular combination for the result specified Another example is to combine the breadless breading mixture or composition as follows:
1) Use about 50% almond meal;
2) Use about 23% flax seed meal;
3) Use about 23% soy flour;
4) Use about 4% spices.

The percentages above are based on the total ingredients of the ingredients listed above. However, the spices are not required, so that if such spices are not used, the 4% weight of such spices would be spread out as follows: add an extra 2% to the almond meal, 1% to the flax seed meal and 1% to the soy flour.

Upon coating and cooking the food product coated with the breadless breading of the present invention, excellent and uniform adherence of the food coating of the present invention to the food product is observed as well as a coating with improved crispness. This uniform adherence is observed even when the food product is irregularly shaped (e.g., chicken pieces), or even when the food product is exposed to moisture, thus overcoming difficulties which have been common in the art.

The coated and cooked food product is also more nutritious as a result of the low caloric content and lack of cholesterol, saturated fat, oil, and gluten in the food coating composition of the present invention.

While the above description contains many specifics, these should not be construed as limitations on the scope of the invention, but rather as an exemplification of one preferred embodiment thereof. Many other variations are possible. Accordingly, the scope of the present invention should be determined not by the embodiment(s) illustrated, but by the appended claims and their legal equivalents

Thus, the foregoing is considered as illustrative only of the principles of the invention. Further, since numerous modifications and changes will readily occur to those skilled in the art, it is not desired to limit the invention to the exact percentages and process shown and described, and accordingly, all suitable modifications and equivalents may be resorted to, falling within the scope of the invention.

1. The product of the present invention, comprising:
almond meal;
flax seed meal; and
soy flour, wherein said almond meal, said flax seed meal and said soy flour are mixed together to form said product.

2. The product of claim 1, further comprising a spice.

3. The product of claim 1, further comprising spices.

4. The product of claim 3, wherein said almond meal is about 47% of the total ingredients.

5. The product of claim 3, wherein said flax seed meal is about 23% of the total ingredients.

6. The product of claim 3, wherein said soy flour is about 23% of the total ingredients.

7. The product of claim 3, wherein said spices are about 7% of the total ingredients.

8. The product of claim 3, wherein said spices are pepper, dehydrated garlic, salt, paprika, dehydrated onions and red pepper.

9. The product of the present invention, comprising:
almond meal wherein said almond meal is about 47% of the total ingredients;
flax seed meal wherein said flax seed meal is about 23% of the total ingredients;
soy flour, wherein said soy flour is about 23% of the total ingredients; and
spices wherein said spices are about 7% of the total ingredients, whereby said almond meal, said flax seed meal, said soy flour and said spices are mixed together to form said product.

10. The product of claim 9, wherein said spices are pepper, dehydrated garlic, salt, paprika, dehydrated onions and red pepper.

11. A product of the present invention, made by the process comprising the steps of:
(a) weighing soy flour;
(b) weighing flax seed meal;
(c) weighing almond meal;
(d) weighing the spice or spices;
(e) pouring said soy flour into a bowl;
(f) adding said flax seed meal into the bowl;
(g) adding said almond meal into the bowl;
(h) mixing said soy flour, said flax seed meal and said almond meal;
(i) adding said spice or spices into the bowl; and
(j) mixing said soy flour, said flax seed meal, said almond meal and said spice or spices evenly together.

12. The process of claim 11, wherein said almond meal is about 47% of the total ingredients.

13. The process of claim 11, wherein said flax seed meal is about 23% of the total ingredients.

14. The process of claim 11, wherein said soy flour is about 23% of the total ingredients.

15. The process of claim 11, wherein said spice or spices are about 7% of the total ingredients.

16. The process of claim 11 wherein said spices are pepper, dehydrated garlic, salt, paprika, dehydrated onions and red pepper.
